(19) United States
(12) Patent Application Publication
(10) Pub. No.: US 2003/0033902 A1
(43) Pub. Date: Feb. 20, 2003

(54) Retractable structure of a bicycle pedal

(76) Inventor: Chin-Pin Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/931,884

(22) Filed: Aug. 20, 2001

(51) Int. Cl. B62M 3/08

(52) U.S. Cl. 74/594.7; 74/594.1

(57) ABSTRACT

A retractable structure of a bicycle pedal is disclosed. The retractable structure is characterized in that a bottom end of the crank arm body is a hollow cavity space holding a combinative positioning frame plate, corresponding to the frame plate, a sliding slot is provided and the inner edge of the external end of the frame plate is protruded with a positioning protruded edge for the positioning of a covered rotating seat, an insertion side of the frame plate is provided with an insertion slot for the easy positioning of an elastic body, the two sides of the rotating seat corresponding to the sliding slot is provided with a protruded peg directly insertion into the sliding slot and stopped by the shape of the slot, and achieve the corresponding rotating operation, a screw hole seat being provided at one side of the rotating seat and is screwed to the screw rod at one end of the pedal, thereby the rotatably controlling of the rotating seat, the pedal is simultaneously controlled.

### BACKGROUND OF THE INVENTION

(a) Field of the Invention

The present invention relates to a retractable structure of a bicycle pedal, and in particular, the pedal can be retracted to the side of the crank arm of the bicycle.

(b) Description of the Prior Art

Conventional crank arm of a bicycle pedal is an independent structure having a screw hole seat at the bottom end, and one protruded end of the pedal is screwed to the screw hole seat to form an L-shaped structure. As the pedal is protruded from the crank arm, the packing of the pedal together with the crank arm is not easy and therefore, the cost of packing is high. FIGS. 11 to 13 show conventional folding structure of bicycle pedal, comprising a locking frame 30, which cannot be folded, having one end being provided with a screwing end 31. The two sides of the frame are extended to form a wing-like structure having mounted with an engaging slot 32 for the screwing end 31 to be directly mounted to the hole seat at one end of the crank arm 40. The two sides of the locking frame 30 are protruded with positioning rod 33. A recess 34 is provided at the center of the bottom end of the frame body for the insertion of the pedal plate 41.

The center of the pedal plate 41 is a U-shaped structure having a sliding slot 42 along the two lateral sides. The bottom end of the U-shaped slot is relatively narrower, and the center of the bottom end is protruded with an insertion ring 43. When the insertion ring 43 is located at the slot hole 34 and the positioning rod 33 is also inserted onto the bottom end of the sliding slot 42, a securing mounting is obtained. When the above structure is to be folded, the fastening plate 44 has to be fastened and the pedal plate 41 has to be pulled out so that the entire positioning rod 33 and the insertion ring 43 are dislocated from the insertion position and then the pedal plate is then folded upward. This type of folding is only allowing about ⅓ to ½ of the structure being folded. Accordingly, it is an object of the present invention to provide a retractable structure of a bicycle pedal, which mitigates the above drawbacks.

### SUMMARY OF THE INVENTION

Accordingly, it is an object of the present invention to provide a retractable structure of a bicycle pedal, characterized in that the bottom end of the crank arm body is a hollow cavity space holding a combinative positioning frame plate, corresponding to the frame plate, a sliding slot is provided and the inner edge of the external end of the frame plate is protruded with a positioning protruded edge for the positioning of a covered rotating seat, an insertion side of the frame plate is provided with an insertion slot for the easy positioning of an elastic body, the two sides of the rotating seat corresponding to the sliding slot is provided with a protruded peg directly insertion into the sliding slot and stopped by the shape of the slot, and achieve the corresponding rotating operation, a screw hole seat being provided at one side of the rotating seat and is screwed to the screw rod at one end of the pedal, thereby the rotatably controlling of the rotating seat, the pedal is simultaneously controlled.

Yet another object of the present invention to provide a retractable structure of a bicycle pedal, wherein the manufacturing cost is greatly reduced.

### BRIEF DESCRIPTION OF THE DRAWINGS

FIG. 1 is a perspective exploded view of the present invention.

FIG. 2 is a perspective view of the pedal of the present invention.

FIG. 3 is a schematic view showing the retracting of the pedal of the present invention.

FIG. 4 is a schematic view showing the folding of the pedal of the present invention.

FIG. 5 is a perspective view of another preferred embodiment of the present invention.

FIG. 6 is a schematic view showing the retracting of the pedal of FIG. 5.

FIG. 7 is a schematic view showing the folding of the pedal of FIG. 5.

FIG. 8 is a perspective view of the pedal after folding.

FIG. 9 is a reference view showing another structure of the pedal of the present invention.

FIG. 10 is a plan view of the pedal in FIG. 9.

FIG. 11 is an exploded perspective view of a conventional pedal.

FIG. 12 illustrates the operation of a conventional pedal.

FIG. 13 is a schematic view of the folding of the conventional pedal.

### DETAILED DESCRIPTION OF THE PRESENT INVENTION

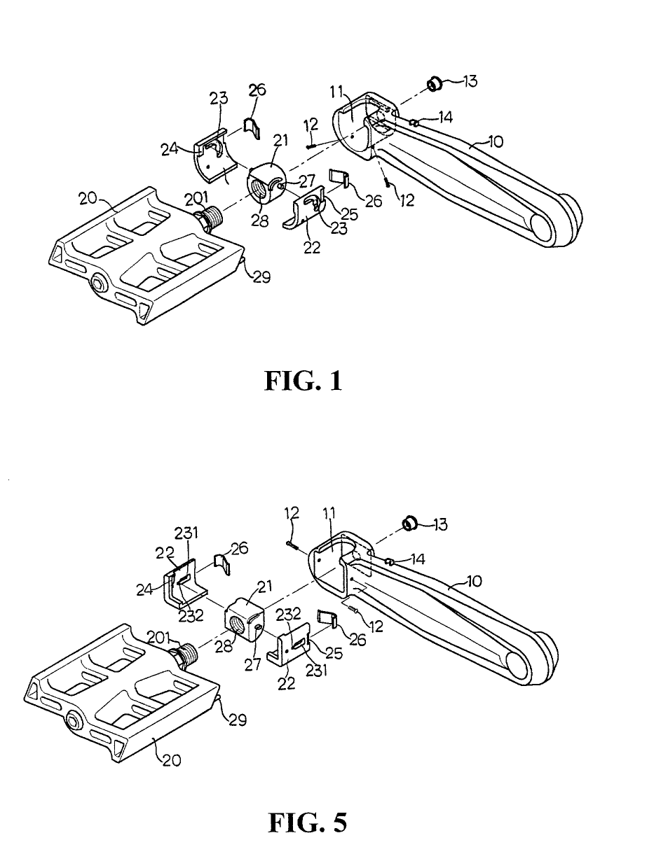

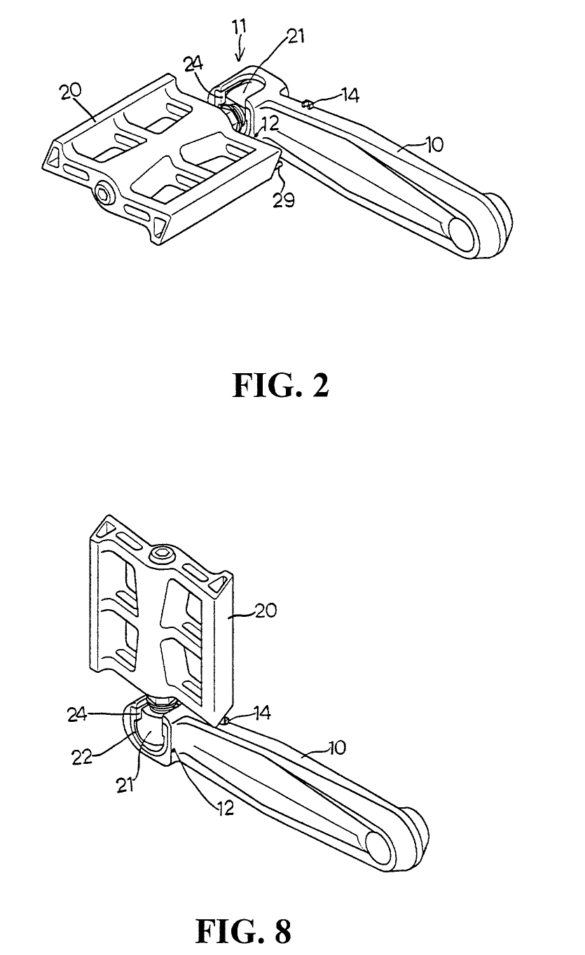

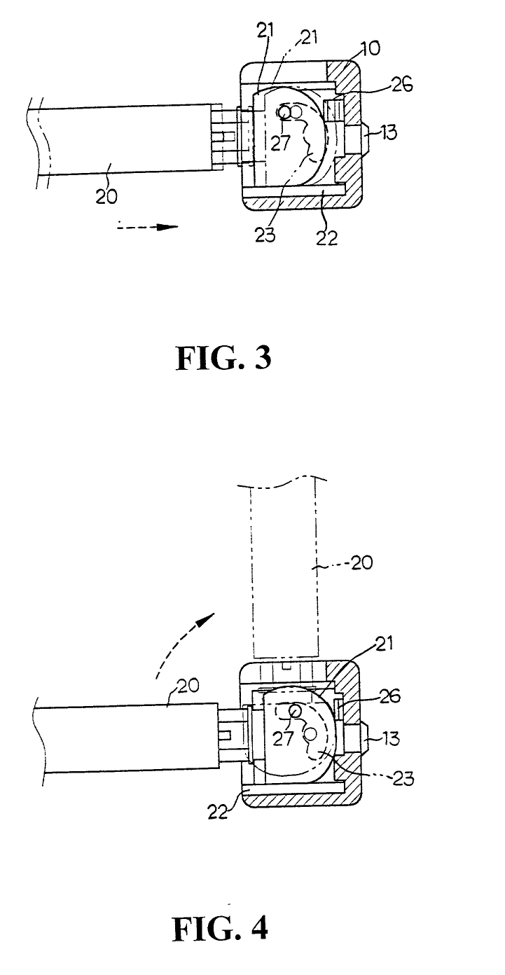

Referring to FIGS. 1 to 4 and 8, there is shown the retractable structure of bicycle pedal comprising a crank arm body 10, pedal 20 and a rotating seat 21 for the connection of the pedal 20 and the crank arm body 10. The bottom end of the crank arm body 10 is a hollow cavity space 11 for the accommodation of a positioning frame plate 22, which is a plate formed as a unit or a plurality of plates. Arc-shaped sliding slot 23 is formed at position corresponding to the frame plate 22. The inner edge of the external end is provided with a positioning protruded edge 24 for the covered rotating seat 21 therein to assure dislocation from the rotating seat 21. The frame plate 22 is inserted into an insertion slot 25 located at the frame side at one end of the crank arm body 10 for the mounting of an elastic element 26. The elastic element 26 is either an elastic plate or an elastic element. At the sides of the rotating seat 21, corresponding to the sliding slot 23, a protruded peg 27 is provided for direct insertion of the peg 27 into the sliding slot 23 so as to perform the relative rotating operation. One side of the rotating seat 21 is a screw hole seat 28 for the screw rod 201 at one end of the pedal 20 for directly mounting.

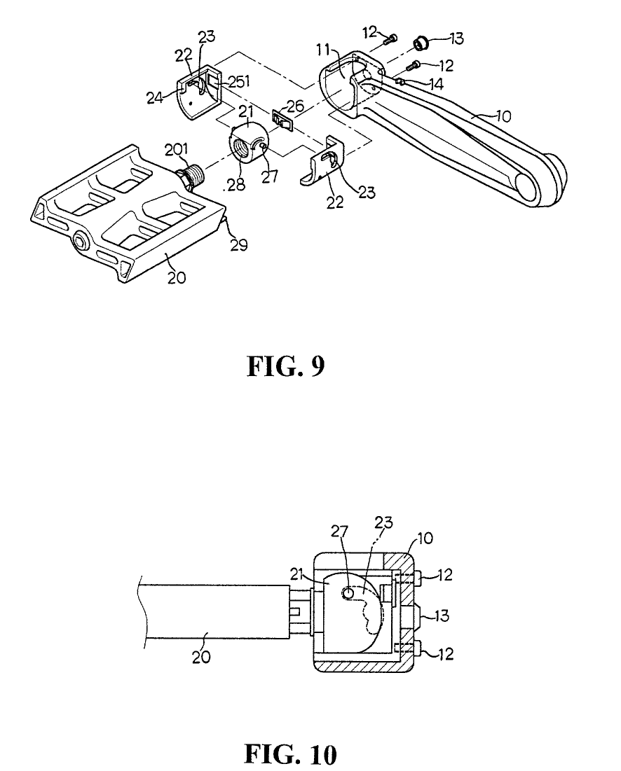

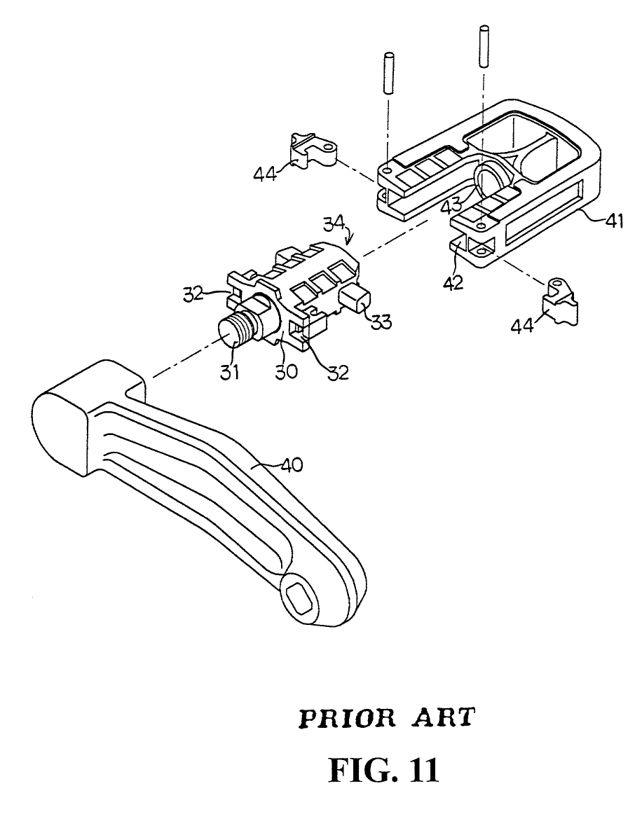

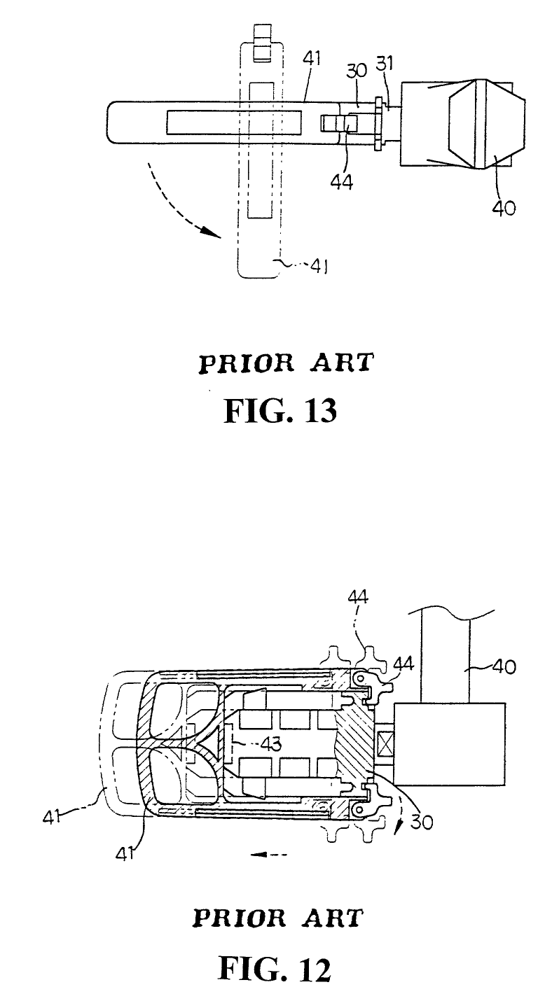

By means of rotating control of the rotating seat 21, the pedal 20 is simultaneously controlled. The positioning frame plate 22 is mounted together with the crank arm body 10 by a positioning screw bolt 12 and the shape of the positioning plate 22 is the same as that of the cavity space 11, i.e., the bottom edge of the insertion side is a seal structure. As shown in FIGS. 9 and 10, a recess is provided for the elastic element 26, and is located at the center of the bottom of the frame plate 22, and the screw bolt 12 of the frame plate 22 is mounted at the back bottom face of the body 10 so that the entire body 10 has an aesthetic appearance. A lubricating oil introduction hole 13 is provided on the body 10 so that the rotating seat 21 can be easily maintained and the rotating control of the pedal is smooth.

In operating the retraction structure, the pedal 20 is pressed at the axial direction, and the elastic element 26 is pressed so that the end face of the rotating seat 21 dislocates from the protruded edge 24. The pedal 20 is rotated inwardly, i.e., the crank arm body 10 is folded at one side. A positioning element 14 is provided at a position corresponding to the side of the crank arm body 10 and the protrusion 29 at the pedal 29 can be easily engaged and in the folding operation, the pedal 20 is positioned.

When the pedal 20 is to be used, the pedal 20 is lightly turned to an appropriate angle and it will dislocate from the engagement position. The pedal 20 is then rotated along the external side, due to the restriction of the arc-shaped sliding slot 23, the rotating seat 21 will operate in a reverse direction so that the pedal 20 turns to a position perpendicular to the crank arm body 10. The elastic restoration of the elastic element 26 causes the end face of the rotating seat 21 to urge the protruded edge 24 at a stable position for riding.

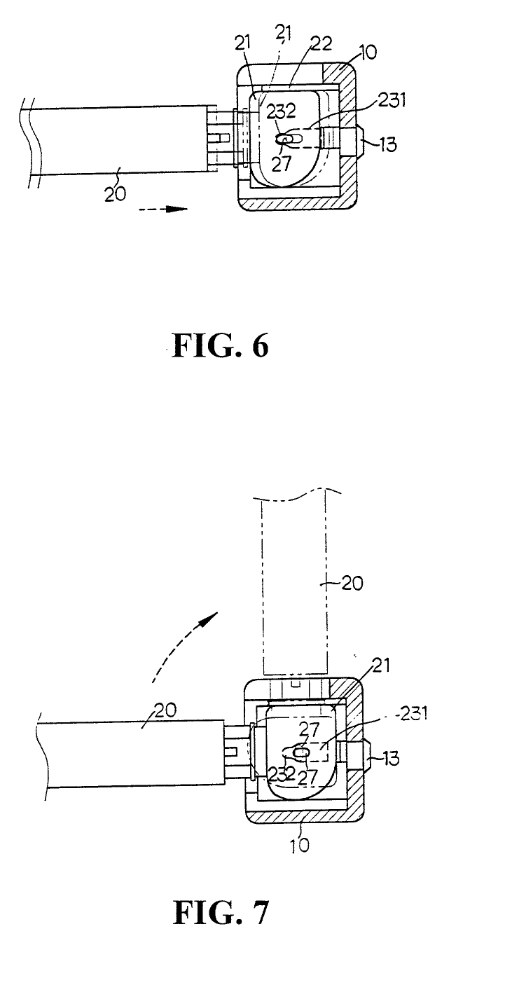

As shown in FIGS. 5 to 7, the peg 27 on the rotating seat 21 is a rectangular shape. The sliding slot 231 on the frame plate 22 is in a straight-line arrangement. The end terminal of the outer side of frame plate 22 has a slot 232 having a narrower diameter to allow insertion. After the pedal is locked and combined, and is extended outward, the crank arm 10 is in a 90° position and the peg 27 will be urged by the elastic element 26 and will be inserted into the slot 232 to secure the pedal.

When the pedal is to be folded, the pedal 20 is pressed inward of the crank arm so that the elastic element 26 is pressed to an appropriate height so that the peg 27 is moved to the wider face of the sliding slot 231. The pedal 20 can be reversibly turned within the wider slot. The positioning element 14 provided at the lateral side of the crank arm body 10 allows the mounting of the pedal 20. When the pedal 20 is to be used again, the pedal 20 is turned toward the outside thereof and the pedal 20 is dislocated from the engagement. The pedal 20 is then turned to the normal position and via the urging of the elastic element 28, the pedal 20 is restored to its original position.

In another preferred embodiment the peg 27 can be arranged eccentrically, and together with the arc-shaped slot 23, it can be used with a cylindrical rod. When it is located at the center position of the rotating seat 21, the side of the peg 27 needs to be smooth or a special shape, which allows reversibly mounting.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

1. A retractable structure of a bicycle pedal having a crank arm body, a pedal and a rotating seat element, characterized in that the bottom end of the crank arm body is a hollow cavity space holding a combinative positioning frame plate, corresponding to the frame plate, a sliding slot is provided and the inner edge of the external end of the frame plate is protruded with a positioning protruded edge for the positioning of a covered rotating seat, an insertion side of the frame plate is provided with an insertion slot for the easy positioning of an elastic body, the two sides of the rotating seat corresponding to the sliding slot is provided with a protruded peg directly insertion into the sliding slot and stopped by the shape of the slot, and achieve the corresponding rotating operation, a screw hole seat being provided at one side of the rotating seat and is screwed to the screw rod at one end of the pedal, thereby the rotatably controlling of the rotating seat, the pedal is simultaneously controlled.

2. The retractable structure of a bicycle pedal of claim 1, wherein the sliding slot is designed into unequal width slot, and the smaller width face is formed into the rotating seat for positioning.

3. The retractable structure of a bicycle pedal of claim 1, wherein the peg is made into a round shape or cylindrical shape.

4. The retractable structure of a bicycle pedal of claim 1, wherein the positioning frame plate is formed as one unit or are a multiple plates.

5. The retractable structure of a bicycle pedal of claim 1, wherein the elastic body is an elastic plate or a spring.

6. The retractable structure of a bicycle pedal of claim 1, wherein the external side of the crank arm body is mounted with a positioning screw bolt to the positioning frame plate so as to secure the frame plate.

7. The retractable structure of a bicycle pedal of claim 1, wherein the crank arm body is provided with a lubricating oil introduction device.

8. The retractable structure of a bicycle pedal of claim 1, wherein the crank arm body or the pedal side face is provided with a positioning element for the engaging of the pedal after the pedal is retracted.

9. The retractable structure of a bicycle pedal of claim 1, wherein the positioning element is protruded with a rubber pad.

10. The retractable structure of a bicycle pedal of claim 8, wherein the peg of the rotating seat is eccentrically mounted.

11. The retractable structure of a bicycle pedal of claim 1, wherein the frame plate has the shape of the cavity space of the crank arm body, and the bottom edge of the interior of the frame plate is provided with a slot to accommodate the elastic element.
